(19) United States
(12) Patent Application Publication
(10) Pub. No.: US 2024/0233204 A1
(43) Pub. Date: Jul. 11, 2024

(54) EMOTION EXPRESSION ATTACHING METHOD, EMOTION EXPRESSION ATTACHING APPARATUS AND PROGRAM

(71) Applicant: NIPPON TELEGRAPH AND TELEPHONE CORPORATION, Tokyo (JP)

(72) Inventors: Ayaka SANO, Tokyo (JP); Shunichi SEKO, Tokyo (JP)

(21) Appl. No.: 18/572,520

(22) PCT Filed: Jul. 5, 2021
(86) PCT No.: PCT/JP2021/025311

§ 371 Date: Dec. 20, 2023

(51) Int. Cl. G06T 11/00; G06V 20/40; G06V 40/16

(52) U.S. Cl. CPC G06T 11/00; G06V 20/41; G06V 40/174

(57) ABSTRACT

An emotion of a person in a video can be easily understood by a computer to execute: an identifying step of identifying an expression mode that is understandable by a user with respect to a certain emotion of the person on the basis of information input by the user; and an attaching step of attaching information, which indicates the certain emotion, to the video in the expression mode identified by the identifying step in a case where it is estimated that the person included in the video displayed for the user has expressed the certain emotion.

### TECHNICAL FIELD

The present invention relates to an emotion expression attaching method, an emotion expression attaching apparatus, and a program.

### BACKGROUND ART

Emotion is felt by a person for a certain event, and a certain emotion tends to be interpreted differently by a person. In communication, the recipient of the emotion information estimates the emotion of the sender from the linguistic information and non-linguistic information such as voice tone and gesture, but it is not always easy to understand the emotion as intended by the sender of the emotion information. In the case of the web meeting, information that can be used to read the emotion of the sender is reduced as compared with the case of face-to-face, and thus it is more difficult.

Conventionally, there has been proposed a technique of estimating an emotion, creating a CG effect for the estimated emotion, and attaching the CG effect to a video of a sender to emphasize the emotion, thereby conveying the emotion to a recipient in an easy-to-understand manner.

### CITATION LIST

### Non Patent Literature

Non Patent Literature 1: Daiki Yokoyama, Sachiko Kodama, “Emotion FX: An automatic CG effect generation application that enhances facial emotions in video in real time”, [online], Internet <URL:http://www.interaction-ipsj.org/proceedings/2020/data/pdf/1A-10.pdf>

### SUMMARY OF INVENTION

### Technical Problem

In the conventional technique, by adding a CG effect for the estimated emotion, it is possible to convey the emotion to the recipient in an easy-to-understand manner. However, since the understanding of the additional information is not always the same among all receivers, the same feeling is not easily conveyed to all persons in the conventional technique in which the information is uniformly added. That is, although a certain receiver may understand as intended by the sender, it is conceivable that another receiver may receive differently from the intention of the sender or make understanding rather difficult.

The present invention has been made in light of the above points, and an object thereof is to facilitate understanding of emotions of persons in a video.

### Solution to Problem

Therefore, in order to solve the above problems, a computer executes: an identifying step of identifying an expression form that is understandable by a user for a certain emotion of a person on the basis of information input by the user; and an adding step of adding information indicating the certain emotion to a video in the expression form identified by the identifying step in a case where it is estimated that a person included in the video displayed to the user has expressed the certain emotion.

### Advantageous Effects of Invention

The emotion of the person in the video can be easily understood.

### BRIEF DESCRIPTION OF DRAWINGS

FIG. 1 is a diagram illustrating a hardware configuration example of an emotion expression adding device 10 according to a first embodiment.

FIG. 2 is a diagram illustrating a functional configuration example of the emotion expression adding device 10 according to the first embodiment.

FIG. 3 is a diagram illustrating one example of a correspondence table of user characteristics and additional contents according to the first embodiment.

FIG. 4 is a diagram illustrating a functional configuration example of an emotion expression adding device 10 according to a second embodiment.

FIG. 5 is a diagram illustrating one example of a questionnaire screen.

FIG. 6 is a diagram illustrating one example of evaluation information.

FIG. 7 is a diagram illustrating a functional configuration example of an emotion expression adding device 10 according to a third embodiment.

FIG. 8 is a diagram illustrating an example of an additional content possibility set corresponding to a user characteristic “outward property: high” in the third embodiment.

FIG. 9 is a diagram illustrating a functional configuration example of an emotion expression adding device 10 according to a fourth embodiment.

FIG. 10 is a diagram illustrating an example of an additional content possibility set corresponding to a user characteristic “outward property: high” in the fourth embodiment.

FIG. 11 is a diagram illustrating an example of a summation result.

### DESCRIPTION OF EMBODIMENTS

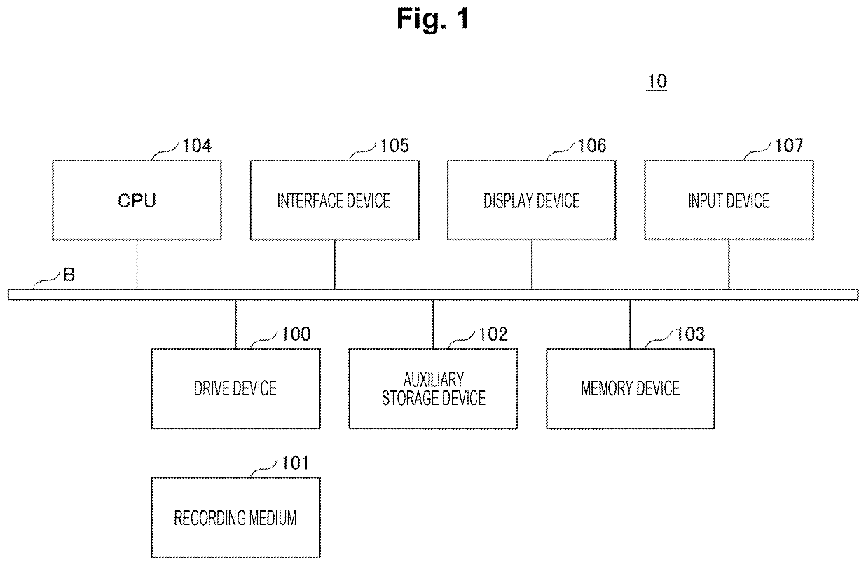

Hereinafter, embodiments of the present invention will be described with reference to the drawings. FIG. 1 is a diagram illustrating a hardware configuration example of an emotion expression adding device 10 (emotion expression attaching apparatus) according to a first embodiment. The emotion expression adding device 10 in FIG. 1 has a drive device 100, an auxiliary storage device 102, a memory device 103, a CPU 104, an interface device 105, a display device 106, an input device 107, and the like, which are connected to one another via a bus B.

A program for realizing processing in the emotion expression adding device 10 is provided by a recording medium 101 such as a CD-ROM. When the recording medium 101 storing the program is set in the drive device 100, the program is installed on the auxiliary storage device 102 from the recording medium 101 via the drive device 100. Here, the program is not necessarily installed from the recording medium 101 and may be downloaded from another computer via a network. The auxiliary storage device 102 stores the installed program and also stores necessary files, data, and the like.

When an instruction to start the program is received, the memory device 103 reads and stores the program from the auxiliary storage device 102. The CPU 104 implements a function related to the emotion expression adding device 10 in accordance with a program stored in the memory device 103. The interface device 105 is used as an interface connecting to a network. The display device 106 displays a graphical user interface (GUI) and the like by the program. The input device 107 includes a keyboard, a mouse, and the like, and is used to input various operation instructions.

Note that, in the present embodiment, the emotion expression adding device 10 is assumed to be a terminal used by each user who interacts via a video transferred via a network, such as a web meeting. However, the emotion expression adding device 10 may be a server (e.g., a cloud side computer group) that relays a web meeting or the like. In the present exemplary embodiment, a user on a video transmission side (a side on which a feeling is conveyed by the video) is particularly referred to as a “sender.” Moreover, when simply referred to as a “user,” the user means a receiver.

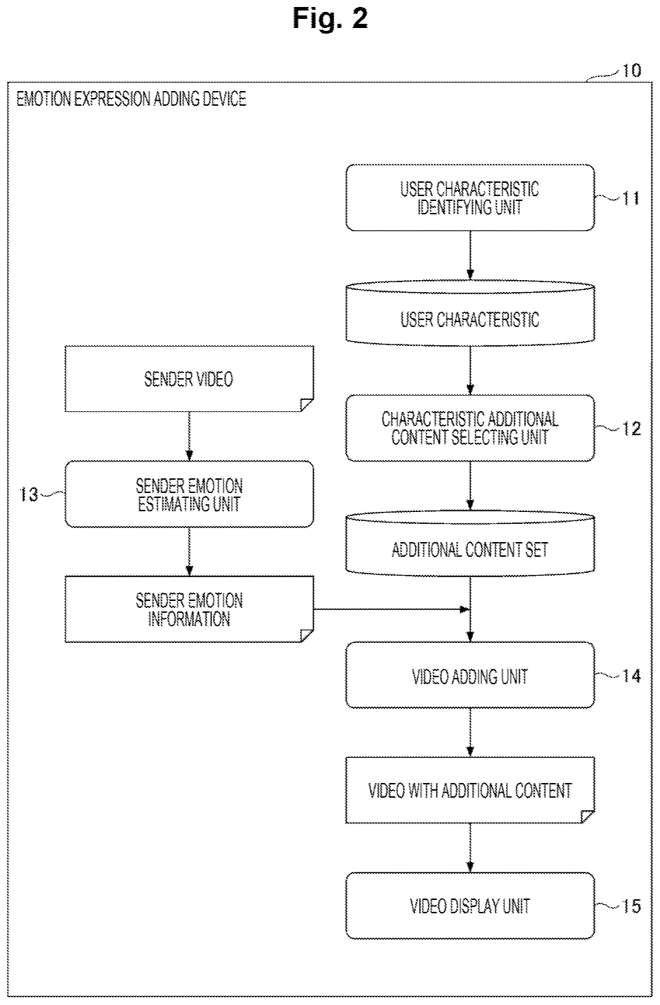

FIG. 2 is a diagram illustrating a functional configuration example of the emotion expression adding device 10 according to the first embodiment. In FIG. 2, the emotion expression adding device 10 has a user characteristic identifying unit 11, a characteristic additional content selecting unit 12, a sender emotion estimating unit 13, a video adding unit 14, and a video display unit 15. These units are implemented through a process of causing the CPU 104 to execute one or more programs installed in the emotion expression adding device 10.

The user characteristic identifying unit 11 identifies a characteristic of the user (hereinafter, referred to as a “user characteristic”) on the basis of information input by the user who is the recipient of the emotion. The user characteristic refers to a characteristic of how the user feels and thinks about the event.

Specifically, for example, at the first startup of a program that causes a computer to function as the user characteristic identifying unit 11, the user characteristic identifying unit 11 receives answers to a questionnaire such as Big five or a cognitive characteristic test from the user, and identifies the user characteristic on the basis of the answers. For example, the user characteristic identifying unit 11 selects one class (type) as the characteristic of the user from a plurality of classes (types) predetermined (classified) for the characteristic of the person, such as “outward characteristic: high”, “open characteristic: high”, and “integrity: high”. Note that the class of the user characteristic in the present embodiment is based on Big five. The identification of the user characteristic from the answers to the questionnaire such as Big five or the cognitive characteristic test may be performed, for example, on the basis of the information disclosed in “Tsutomu NAMIKAWA, Iori TANI, Takafumi WAKITA, Ryuichi KUMAI, Ai NAKANE, Hiroyuki NOGUCHI, Study on Development, Reliability, and Validity of Big Five Scale-shortened Version, Psychological Research, Vol. 83, No. 2, p. 91-99, https://www.jstage.jst.go.jp/article/jjpsy/83/2/83_91/_pdf/-char/ja.”

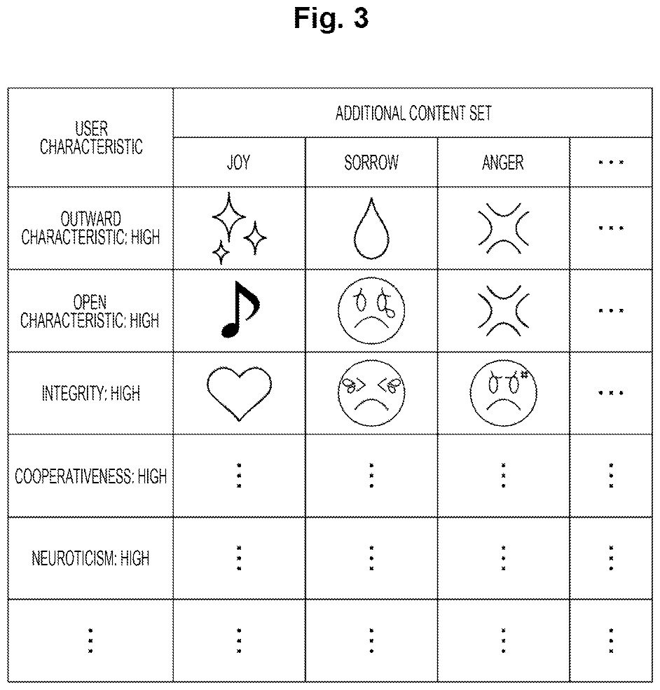

The characteristic additional content selecting unit 12 selects a set (hereinafter, referred to as an “additional content set”) of content (hereinafter, referred to as an “additional content”) to be added to the video in accordance with the emotion of the sender in order to express various kinds of emotions of the sender on the basis of the user characteristic (hereinafter, referred to as a “target user characteristic”) identified by the user characteristic identifying unit 11. Such selection is performed, for example, on the basis of a correspondence table between the user characteristic and the additional content set as illustrated in FIG. 3. The characteristic additional content selecting unit 12 selects an additional content set (additional content for each emotion of the sender) included in the row corresponding to the target user characteristic in the correspondence table. For example, in a case where the target user characteristic is “open characteristic: high”, the additional content set (additional content set in which joy is “quarter note”, sorrow is “left eye crying face”, and anger is “blue streak”) in the second row is selected. That is, since it is considered that the most easily understandable additional contents are different in accordance with the user characteristic, different additional contents are selected even if the contents express the same emotion. For example, FIG. 3 is based on an example in which a person with “open characteristic: high” can easily understand a heart mark as more joy than a mark of a musical note. Hereinafter, the additional content set selected by the characteristic additional content selecting unit 12 is referred to as a “target additional content set”.

The sender emotion estimating unit 13 periodically (e.g., every 0.1 second video section) estimates the emotion expressed by the sender from the video of the sender (the video including the sender as the subject) during the Web meeting, for example. The emotion estimation based on the video can be performed using a known technique such as “Cognitive Services Face API (https://azure.microsoft.com/ja-jp/services/cognitive-services/face/#demo)”, for example. The sender emotion information that is the estimation result of the sender emotion estimating unit 13 may include not only the type of emotion (joy, sorrow, anger, etc.) but also the intensity of the emotion (small, medium, large, etc.) and the like.

The video adding unit 14 identifies the additional content corresponding to the emotion (of the sender) indicated by the sender emotion information output from the sender emotion estimating unit 13 in the target additional content set as an expression mode in which the user can easily understand the emotion. The video adding unit 14 adds (superimposes or combines) the identified additional content to the video of the sender by image processing, thereby generating a video (hereinafter, referred to as “video with additional content”) to which the additional content is added.

The video display unit 15 displays the video with the additional content on the display device 106.

As described above, according to the first embodiment, the additional content changes depending on the characteristics of the recipient for a certain emotion of the sender. Therefore, the emotion can be conveyed in accordance with the characteristics of the recipient, and the emotion of the sender can be easily conveyed to each recipient. That is, it is possible to facilitate understanding of the emotions of the person in the video.

Next, a second embodiment will be described. In the second embodiment, differences from the first embodiment will be described. The points not specifically mentioned in the second embodiment may be the same as those in the first embodiment.

In the second embodiment, a method (emotion expression attaching method) is disclosed in which evaluation information on a user for a video with additional content is acquired in advance, an optimum additional content is selected on the basis of the evaluation information, and an emotion of a sender is expressed by the selected additional content.

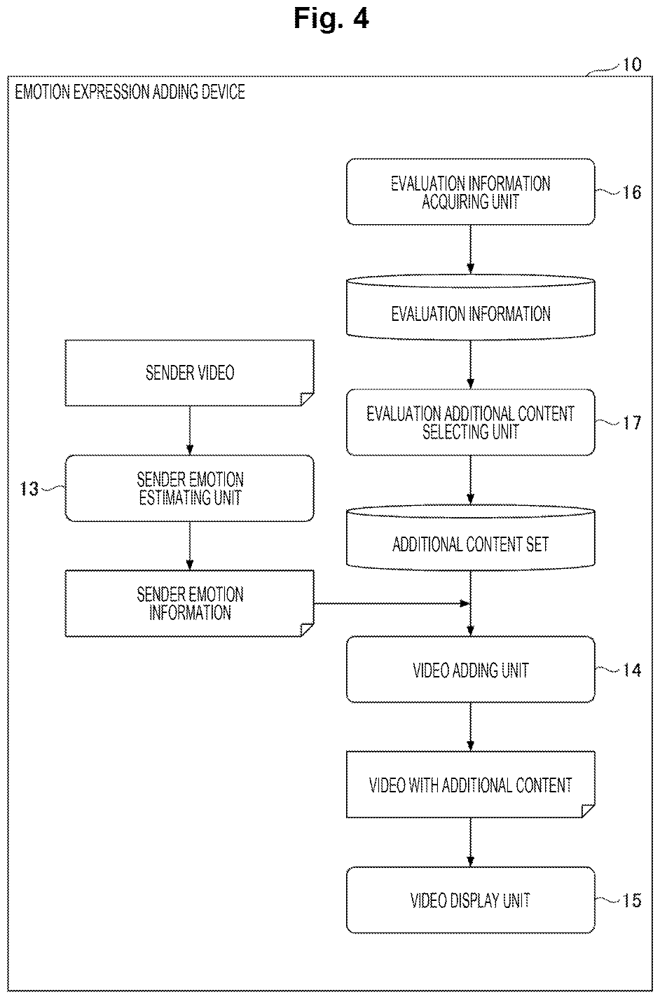

FIG. 4 is a diagram illustrating a functional configuration example of an emotion expression adding device 10 according to the second embodiment. In FIG. 4, the same or corresponding parts as those in FIG. 2 are denoted by the same reference signs, and the description thereof will be omitted as appropriate.

In FIG. 4, the emotion expression adding device 10 further has an evaluation information acquiring unit 16 and an evaluation additional content selecting unit 17. These units are implemented through a process of causing the CPU 104 to execute one or more programs installed in the emotion expression adding device 10. Note that the emotion expression adding device 10 according to the second embodiment does not have a user characteristic identifying unit 11.

The evaluation information acquiring unit 16 identifies an emotion understood by the user for each additional content on the basis of information input by the user who is the recipient of the emotion. For example, the evaluation information acquiring unit 16 displays a questionnaire screen at the time of initial startup of a program that causes a computer to function as the evaluation information acquiring unit 16, and acquires information (hereinafter, referred to as “evaluation information”) indicating how the user understands each additional content via the questionnaire screen.

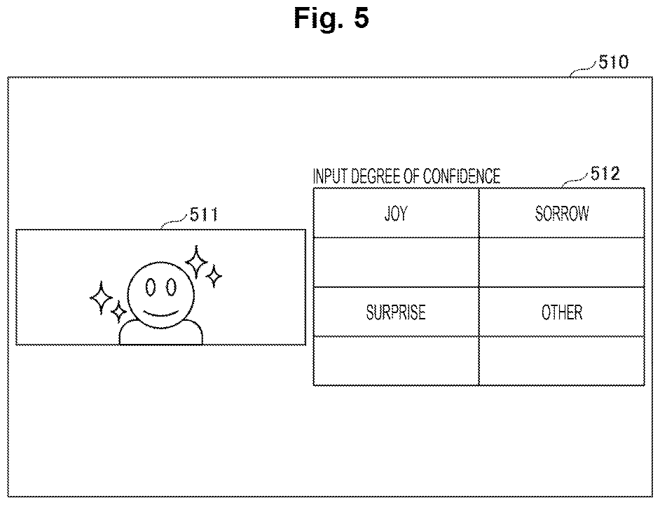

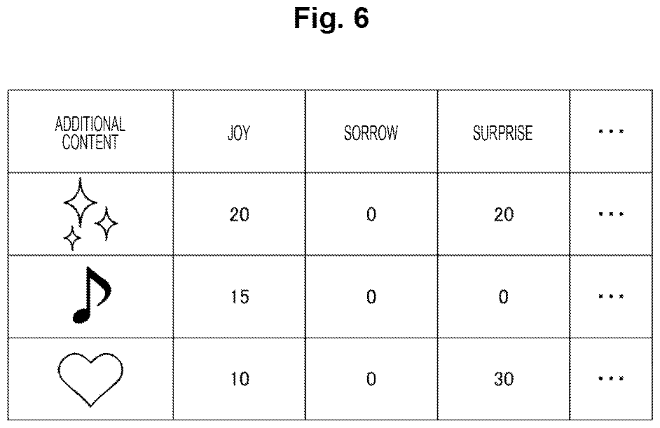

FIG. 5 is a diagram illustrating one example of a questionnaire screen. As illustrated in FIG. 5, a questionnaire screen 510 includes a video display region 511 and a confidence level input region 512. The evaluation information acquiring unit 16 displays (reproduces), in the video display region 511, a video in which a person appears and which is randomly selected from a plurality of videos (videos with additional content) in which the additional content is synthesized in advance. For example, for each type of emotion and for each of a plurality of types of additional contents, a plurality of videos in which the additional contents are synthesized with a video of a person having an expression of the contents is generated in advance, and the plurality of videos is displayed in random order. The user (recipient) refers to (the expression of) the person in the video displayed in the video display region 511 and the additional content synthesized with respect to the video, and inputs the degree of easiness of understanding (hereinafter, referred to as a “confidence level”) of various emotions from the video (the expression of the person and the additional content) to the confidence level input region 512. The evaluation information acquiring unit 16 repeats reception of input of random video display in the video display region 511 and confidence levels of various emotions for the video. As a result, the evaluation information as illustrated in FIG. 6 is obtained. As illustrated in FIG. 6, the evaluation information is information indicating the degree of confidence of various emotions for each additional content. The additional content having a higher confidence level for a certain emotion indicates that the user can easily understand the emotion.

The evaluation additional content selecting unit 17 selects an optimal additional content for the user for each type of emotions (That is, for each column of the table in FIG. 6) on the basis of the evaluation information (FIG. 6) acquired by the evaluation information acquiring unit 16. Two specific examples (1) and (2) will be described below as one example of a method of selecting an additional content for a certain emotion.
(1) Select an additional content having the highest degree of confidence. The reason that the confidence level is the highest is that the user can easily understand the emotion. In the case of FIG. 6, for example, the additional content of the first column is selected for joy.
(2) Each confidence level is different from the highest confidence level value (In the case of the highest confidence level in the additional content, the next highest value is set, and in other cases, the highest confidence level is set.) among different emotions having the same additional content. The additional content having the highest difference among the types of the same emotion is selected. This is because, in a case where the degree of confidence is higher than that of other types of emotions, it is considered that the emotion is less likely to be understood as other emotions. Therefore, in the case of FIG. 6, the additional content of the second row is selected for the joy.

For each emotion, the result selected by any of the above methods is set as the target additional content set in the second embodiment.

Therefore, in the second embodiment, the video adding unit 14 identifies the additional content corresponding to the emotion (of the sender) indicated by the sender emotion information output from the sender emotion estimating unit 13 among the target additional content set selected by the evaluation additional content selecting unit 17 as an expression mode in which the user can easily understand the emotion. The video adding unit 14 adds (superimposes or synthesizes) the identified additional content to the video of the sender by image processing, thereby generating a video with an additional content to which the additional content is added.

The rest is the same as that of the first embodiment.

As described above, the same effects as those of the first embodiment can also be obtained by the second embodiment.

Next, a third embodiment will be described. In the third embodiment, points different from the first or second embodiment will be described. The points not specifically mentioned in the third embodiment may be the same as those in the first embodiment. In the third embodiment, a first method in a case where the first embodiment and the second embodiment are combined is disclosed.

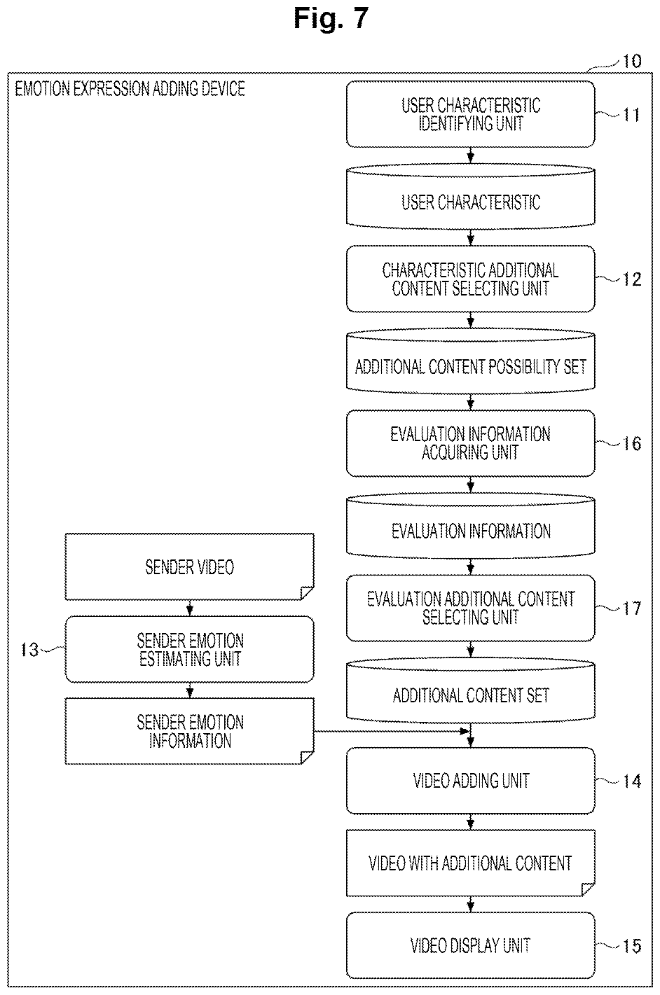

FIG. 7 is a diagram illustrating a functional configuration example of an emotion expression adding device 10 according to the third embodiment. In FIG. 7, the same or corresponding parts as those in FIGS. 2 and 4 are denoted by the same reference signs, and the description thereof will be omitted as appropriate.

A characteristic additional content selecting unit 12 selects (identifies) a set (hereinafter, referred to as an “additional content possibility set”) of possibilities for the additional content for each emotion on the basis of the target user characteristic identified by the user characteristic identifying unit 11.

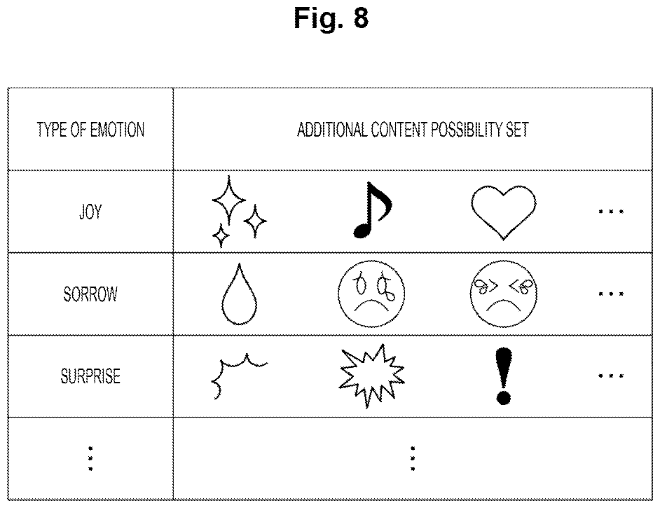

The additional content possibility set is created in advance for each user characteristic. FIG. 8 is a diagram illustrating an example of an additional content possibility set corresponding to a user characteristic “outward property: high” in the third embodiment. As illustrated in FIG. 8, the additional content possibility set includes a set of possibilities for the additional content for each type of emotions.

The characteristic additional content selecting unit 12 selects one additional content possibility set corresponding to the target user characteristic from the additional content possibility sets prepared for each characteristic. Hereinafter, the additional content possibility set selected by the characteristic additional content selecting unit 12 is referred to as a “target additional content possibility set.”

For example, at the first startup of a program that causes a computer to function as the evaluation information acquiring unit 16, the evaluation information acquiring unit 16 acquires, for each type of emotions, evaluation information indicating how the user understands each possibility for the additional content included in the target additional content possibility for the type of emotions. Specifically, the evaluation information acquiring unit 16 displays the questionnaire screen 510 illustrated in FIG. 5 on a plurality of videos obtained by synthesizing each possibility for the additional content corresponding to the emotion in the target additional content possibility set for the video of the person having the expression of the emotion for each type of emotion, thereby accepting the input of the evaluation information (FIG. 6) for each type of emotions and for each possibility.

The rest is the same as that of the second embodiment.

As described above, according to the third embodiment, it is possible to obtain the same effects as those of the above embodiments.

Next, a fourth embodiment will be described. In the fourth embodiment, points different from the first to third embodiments will be described. The points not specifically mentioned in the fourth embodiment may be the same as those in the first to third embodiments. In the fourth embodiment, a second method in a case where the first embodiment and the second embodiment are combined is disclosed.

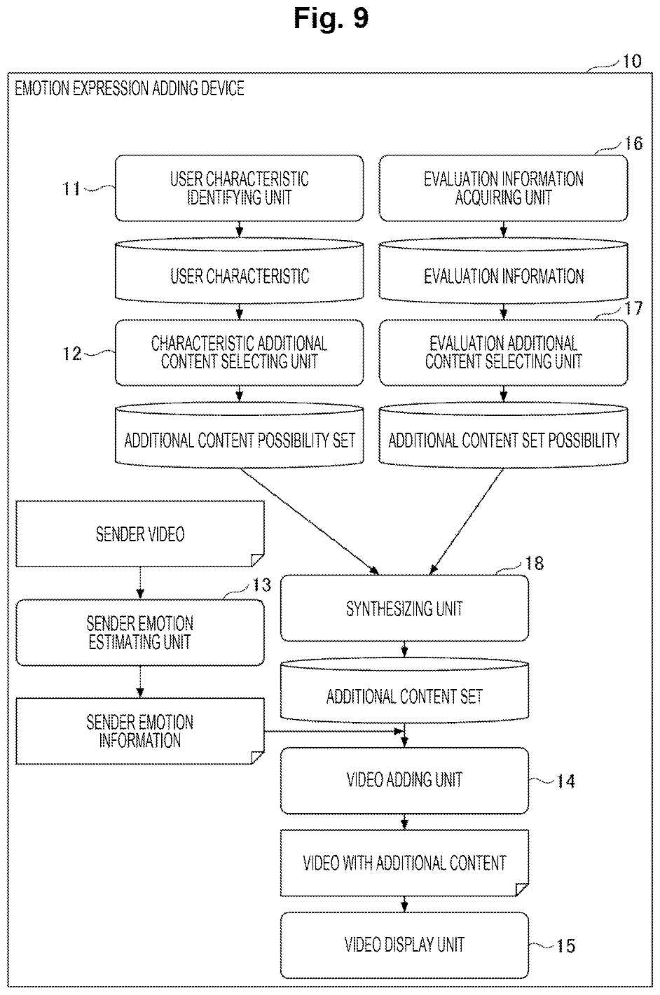

FIG. 9 is a diagram illustrating a functional configuration example of an emotion expression adding device 10 according to the fourth embodiment. In FIG. 9, the same or corresponding parts as those in FIGS. 2, 4 and 7 are denoted by the same reference signs, and the description thereof will be omitted as appropriate.

In FIG. 9, the emotion expression adding device 10 further has a synthesizing unit 18. The synthesizing unit 18 is implemented through a process of causing a CPU 104 to execute one or more programs installed in the emotion expression adding device 10.

A characteristic additional content selecting unit 12 selects an additional content possibility set on the basis of the target user characteristic identified by the user characteristic identifying unit 11.

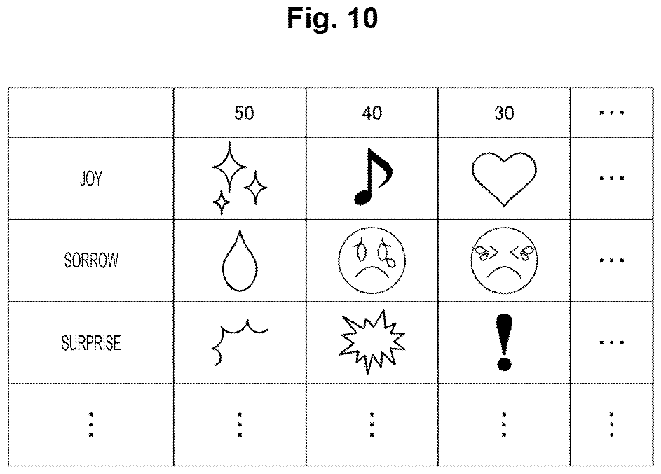

The additional content possibility set is created in advance for each user characteristic. FIG. 10 is a diagram illustrating an example of an additional content possibility set corresponding to a user characteristic “outward property: high” in the fourth embodiment. As illustrated in FIG. 10, in the fourth embodiment, an additional content possibility set corresponding to a certain user characteristic includes, for each type of emotions, a set of possibilities for an additional content for the emotion and a score for each possibility for a person having the user characteristic. A numerical value of each column in the first row of FIG. 10 is a score for the possibility for the additional content corresponding to the column. The score is a numerical value indicating a degree of understandability of each additional content for a person having the characteristic depending on the magnitude of the value, and the larger the value, the easier the understanding is.

The table (additional content possibility set) as illustrated in FIG. 10 is obtained, for example, by asking a subject having the user characteristic to answer a questionnaire performed by the evaluation information acquiring unit 16 for each user characteristic. Specifically, about 10 to 15 subjects are collected for one user characteristic. The answer is analyzed for each user characteristic, and scores are given to each additional content in descending order of results. For example, each additional content is scored in descending order of the number of subjects who answered that the confidence level is 80 or more. Note that the score is an independent index of the confidence level. The score is an index common to people having a certain user characteristic, and the confidence level is an index based on the sense of each individual. For example, in a case where there are persons A and B having the same characteristic “outward characteristic: high,” the scores A and B have the same value, but the confidence level may be different between A and B.

The characteristic additional content selecting unit 12 selects one additional content possibility set corresponding to the target user characteristic from the additional content possibility sets prepared for each user characteristic. Hereinafter, the additional content possibility set selected by the characteristic additional content selecting unit 12 is referred to as a “target additional content possibility set.”

An evaluation information acquiring unit 16 acquires the evaluation information (FIG. 6) by a method similar to that of the second embodiment.

Similar to the second embodiment, the evaluation additional content selecting unit 17 selects an optimal additional content set for the user on the basis of the evaluation information (FIG. 6) acquired by the evaluation information acquiring unit 16. However, in the fourth embodiment, an additional content set selected by the evaluation additional content selecting unit 17 is not deterministic and is treated as a possibility (hereinafter, referred to as an “additional content set possibility”) of the additional content set.

For each combination of the type of emotion and the additional content (each additional content included in the target additional content possibility set), the synthesizing unit 18 adds a score related to the combination in the target additional content possibility set (FIG. 10) selected by the characteristic additional content selecting unit 12 and a confidence level related to the combination in the additional content set possibility (FIG. 6) selected by the evaluation additional content selecting unit 17.

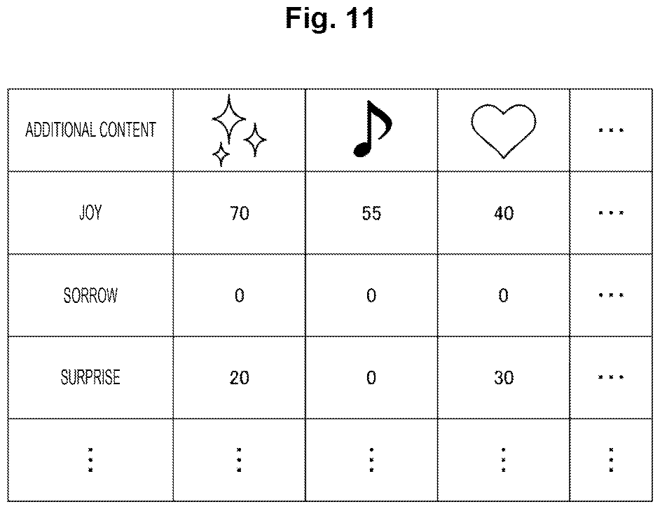

FIG. 11 is a diagram illustrating one example of a summation result. For example, in FIG. 11, 70 for the first column of delight is a summation (sum) of 50 for the first column of delight in FIGS. 10 and 20 for the first row of delight in FIG. 6.

The synthesizing unit 18 selects (characteristics) the additional content to be synthesized with the video for each type of emotion on the basis of the sum calculated for each additional content. Specifically, for each type of emotion, the synthesizing unit 18 selects the additional content corresponding to the maximum sum among the sums calculated for the type of emotion as the additional content for the emotion. For example, in the example of FIG. 11, the additional content of which the sum is 70 is selected as the joy. For each emotion, a set of additional contents (additional content set) selected by the synthesizing unit 18 is set as the target additional content set in the fourth embodiment.

Therefore, in the fourth embodiment, a video adding unit 14 adds (superimposes or synthesizes) the additional content corresponding to the emotion of the sender estimated by the sender emotion estimating unit 13 to the video of the sender by the image processing in the target additional content set selected by the synthesizing unit 18, thereby generating a video with an additional content to which the additional content is added.

As described above, according to the fourth embodiment, it is possible to obtain the same effects as those of the above embodiments.

Note that, in the each of the embodiments described above, the user characteristic identifying unit 11, the characteristic additional content selecting unit 12, and the video adding unit 14, or the evaluation information acquiring unit 16, the evaluation additional content selecting unit 17, and the video adding unit 14, or the user characteristic identifying unit 11, the characteristic additional content selecting unit 12, the video adding unit 14, the evaluation information acquiring unit 16, and the evaluation additional content selecting unit 17, or the user characteristic identifying unit 11, the characteristic additional content selecting unit 12, the video adding unit 14, the evaluation information acquiring unit 16, the evaluation additional content selecting unit 17, and the synthesizing unit 18 are examples of the identifying unit. The video adding unit 14 is one example of the adding unit.

Although the embodiments of the present invention have been described in detail above, the present invention is not limited to such specific embodiments, and various modifications and changes can be made within the scope of the gist of the present invention described in the claims.

### REFERENCE SIGNS LIST

10 Emotion expression adding device
11 User characteristic identifying unit
12 Characteristic additional content selecting unit
13 Sender emotion estimating unit
14 Video adding unit
15 Video display unit
16 Evaluation information acquiring unit
17 Evaluation additional content selecting unit
18 Synthesizing unit
100 Drive device
101 Recording medium
102 Auxiliary storage device
103 Memory device
104 CPU
105 Interface device
106 Display device
107 Input device
B Bus

1. An emotion expression attaching method comprising:
identifying an expression mode that is understandable by a user for a certain emotion of a person on the basis of information input by the user; and
attaching information, which indicates the certain emotion in an expression mode identified at the identifying, to a video in a case where it is estimated that a person included in the video displayed to the user has expressed the certain emotion.

2. The emotion expression attaching method according to claim 1, wherein
the identifying includes identifying a characteristic of the user from among predetermined characteristics on the basis of information input by the user, and identifying an expression mode corresponding to the identified characteristic.

3. The emotion expression attaching method according to claim 1, wherein
the identifying includes prompting the user to input a degree of understandability of the certain emotion for a plurality of expression modes, and identifying an expression mode that is easy for the user to understand from among the plurality of expression modes on the basis of the degree.

4. The emotion expression attaching method according to claim 1, wherein
the identifying includes:
identifying, in a first process, a characteristic of the user from among predetermined characteristics on the basis of information input by the user and identifying a set of expression modes corresponding to the identified characteristic; and
causing, in a second process, the user to input a degree of understandability of the certain emotion for a plurality of the expression modes included in a set of expression modes identified in the first process, and identifying an expression mode that is easy for the user to understand from among the plurality of expression modes on the basis of the degree.

5. The emotion expression attaching method according to claim 1, wherein
the identifying includes:
identifying, in a first process, a characteristic of the user from among predetermined characteristics on the basis of information input by the user and identifying a set of expression modes corresponding to the identified characteristic;
prompting, in a second process, the user to input a degree of understandability of the certain emotion for a plurality of expression modes; and
identifying, in a third process, for each expression mode included in the set of the expression modes identified in the first process, an expression mode that is easy for the user to understand for the certain emotion on the basis of a degree of understandability of the certain emotion by the expression mode for a person having the identified characteristic and a degree of understandability identified in the second process for the expression mode.

6. An emotion expression attaching apparatus comprising:
a processor; and
a memory that includes instructions, which when executed, cause the processor to execute a method, said method including:
identifying an expression mode that is understandable by a user for a certain emotion of a person on the basis of information input by the user; and
attaching information, which indicates the certain emotion in an expression mode identified at the identifying, to a video in a case where it is estimated that a person included in the video displayed to the user has expressed the certain emotion.

7. A non-transitory computer-readable recording medium having computer-readable instructions stored thereon, which when executed, cause a computer including a memory and a processor to execute the emotion expression attaching method according to claim 1.
